(19) United States
(12) Patent Application Publication
(10) Pub. No.: US 2003/0057136 A1
(43) Pub. Date: Mar. 27, 2003

(54) Process for recovering sulfur while sponging light hydrocarbons from hydrodesulfurization hydrogen recycle streams

(76) Inventors: Kenneth E. McIntush, Austin, TX (US); Ken DeBerry, Bothell, WA (US); David W. DeBerry, Austin, TX (US)

Correspondence Address: KLAUBER & JACKSON, 411 HACKENSACK AVENUE, HACKENSACK, NJ, 07601

(21) Appl. No.: 10/223,843

(22) Filed: Aug. 20, 2002

Related U.S. Application Data
(60) Provisional application No. 60/314,197, filed on Aug. 22, 2001.

(51) Int. Cl. C10G 45/02; B01J 8/00

(52) U.S. Cl. 208/209; 208/236; 208/237; 208/213; 422/187

(57) ABSTRACT

In a conventional hydrodesulfurization process sulfur is removed from liquid hydrocarbons by reacting the sulfur in the liquid hydrocarbons with hydrogen to form H₂S. A sour hydrogen gas stream consisting of unreacted hydrogen, H₂S, and undesired light hydrocarbons is then separated from the liquid hydrocarbons, and the H₂S is removed to sweeten the hydrogen stream for recycling. Some of the undesired light hydrocarbons resulting from the reaction may be separated by the purging method discussed. In the present invention efficient separation of the light hydrocarbons is enabled without substantial loss of recyclable hydrogen. Both the H₂S and light hydrocarbons are separated from the sour hydrogen gas stream by passing the stream through an absorber where it is reacted with a nonaqueous liquor. The light hydrocarbons are absorbed in the liquor, from which they are subsequently separated.

### RELATED APPLICATION

This application claims priority from U.S. Provisional Application Serial No. 60/314,197, filed Aug. 22, 2001.

### FIELD OF INVENTION

This invention relates generally to processes and systems for removing hydrogen sulfide from a gaseous stream. More specifically the invention relates to a process for removing H₂S from a refinery hydrodesulfurization gas stream while simultaneously recovering light hydrocarbons from the stream.

### DESCRIPTION OF PRIOR ART

Hydrocarbon liquids such as diesel fuels and other petroleum-derived products often contain high levels of sulfur, commonly in the form of organic sulfurous compounds. For environmental and other reasons such sulfur must be removed or reduced in order to provide a commercially and environmentally acceptable product, e.g., desulfurized diesel fuel. One well known process used for these purposes is hydrotreating, also known as hydrosulfurization (or “HDS”).

FIG. 1 shows a simplified schematic of a conventional prior art hydrotreating system 10. Hydrogen gas 12 and sulfur-bearing hydrocarbon liquids (e.g., diesel 14) are heated and fed to a reactor system 16 containing a catalyst made specifically for hydrotreating. Hydrogen reacts with the organic sulfur compounds at elevate temperatures and pressures to produce H₂S within the reactor. The hydrocarbon liquid 18 is separated at 20 from the (now) sour hydrogen stream 22. The H₂S is then removed from the hydrogen stream 22 e.g., by being passed through an H₂S absorber 24. The sweet hydrogen 26 is then compressed at 28 and recycled. Example pressures and sulfur and H₂S concentrations are shown at various points in system 10; however, pressures may range from as little as 200 psig to as high as 3500 psig depending on the characteristics of the hydrocarbon liquid that is being hydrotreated. Similarly, temperatures may vary somewhat from those shown, perhaps from 80° F. to 150° F. at point 22. The term “BPD” refers to barrels per day. The term “LPTD” refers to long tons per day and refers to the amount of sulfur (as elemental sulfur) in the gas streams.

In conventional HDS systems such as in FIG. 1, a large excess of hydrogen is fed to the reactors. The unreacted hydrogen that remains is then cleaned up and recycled back to the reactor inlet. Fresh hydrogen, usually made by reforming methane (i.e., natural gas), is fed to the system in order to replace hydrogen lost in the system. This fresh hydrogen often contains residual methane. Once methane gets into the hydrotreater system, it builds in concentration and acts as a diluent, reducing the concentration of hydrogen fed to the reactors. Mild cracking of some hydrocarbons in the hydrotreater adds to the problem by generating other light hydrocarbons. For purposes of this specification the term “light hydrocarbons” refers to C₁ to C₆ hydrocarbons, as for example methane, ethane, propanes, butanes, pentanes, and hexanes.

To keep hydrogen concentrations (and reaction rates) high, it is a common practice (as shown at 28 in FIG. 1) to vent or purge a portion of the recycled hydrogen in order to remove light hydrocarbons from the system. The purged stream often contains 55 to 95% hydrogen with the remaining 5 to 45% comprised primarily of light hydrocarbons. The hydrogen lost in the purge is made up with fresh hydrogen 30. Controlling light ends by purging hydrogen from the recycle loop can account for around 10 to 20% or more of total hydrogen consumption.

Aqueous alkanolamine systems are typically used for H₂S removal from hydrogen recycle streams. FIG. 2 shows such a prior art system consisting of the amine unit 32, along with the Claus sulfur recovery unit 34 and tail gas treating (TGT) unit 36 that are required downstream. Reference numerals in FIG. 2 are used commonly with those in FIG. 1 for corresponding elements. The lean aqueous amine solution 38 scrubs H₂S from the sour hydrogen stream 22 in absorber 24. The H₂S gas is then stripped out of the amine solution by a flash vessel 23, and passed to an amine regenerator 25 and fed at 40 to the Claus unit 34. Any gas that remains after the Claus unit (commonly called tail gas) then passes to a conventional TGT unit 36. Although amine systems remove the H₂S, the aqueous scrubbing solution does nothing to address the buildup of methane and other light hydrocarbons in the hydrogen recycle loop. Furthermore, a Claus unit plus a TGT unit are required to convert the H₂S into elemental sulfur and clean up the tail gas.

In U.S. Pat. Nos. 5,733,516, 5,738,834 and 6,416,729 (the entire disclosures of which are hereby incorporated by reference), a process and system are disclosed which use a sulfur-amine nonaqueous sorbent (SANS) for removal of hydrogen sulfide (H₂S) from gas streams. Pursuant to the said process, a sour gas stream containing H₂S is contacted with a nonaqueous sorbing liquor which comprises an organic solvent for elemental sulfur, dissolved elemental sulfur, an organic base which drives the reaction converting H₂S sorbed by the liquor to a nonvolatile polysulfide which is soluble in the sorbing liquor, and an organic solubilizing agent which prevents the formation of polysulfide oil—which can tend to separate into a separate viscous liquid layer if allowed to form. The sorbing liquor is preferably water insoluble as this offers advantages where water soluble salts are desired to be removed. The polysulfide is oxidized to elemental sulfur, still dissolved in the nonaqueous sorbent, by an oxidizing agent such as oxygen or sulfur dioxide. The temperature of the liquor, which up to this point is sufficient to maintain the sulfur in solution, is then lowered, forming sulfur crystals, which are easily removed by gravity settling, filtration, centrifuge, or other standard removal method. Enough sulfur remains dissolved in the liquor following separation of the sulfur crystals that when this solution is reheated and returned to the absorber for recycling in the process, a sufficient amount of sulfur is present to react with the inlet H₂S gas.

### SUMMARY OF INVENTION

Now in accordance with the present invention, removal of H₂S and light ends from the hydrogen recycle stream of a hydrotreater is carried out in a single process unit without purging hydrogen. The sulfur removal system of the invention utilizes nonaqueous chemistry to preferentially absorb both H₂S and light hydrocarbons out of the hydrogen stream. The net effect is that of having a sponge oil system that also removes H₂S and converts it to elemental sulfur. The benefits can be tremendous, especially for refineries that do not currently have a sulfur recovery unit (SRU), which have limited SRU capacity, or which have large seasonal turndown ratios.

In a conventional hydrodesulfurization process sulfur is removed from liquid hydrocarbons by reacting the sulfur in the liquid hydrocarbons with hydrogen to form H₂S. A sour hydrogen gas stream consisting of unreacted hydrogen, H₂S, and undesired light hydrocarbons resulting from the reaction is then separated from the liquid hydrocarbons. The H₂S is then removed to sweeten the hydrogen stream; and at least some of the undesired light hydrocarbons may be separated, e.g. by the purging method discussed. The hydrogen stream (with possible added fresh hydrogen) is then recycled for further reaction in the process.

In the present invention efficient separation of the light hydrocarbons is enabled without substantial loss of recyclable hydrogen. In accordance with the invention both the H₂S and light hydrocarbons are separated from the sour hydrogen gas stream by passing the stream through an absorber where it is reacted with a liquor (i.e., the scrubbing solution) comprising a nonaqueous solvent containing dissolved sulfur, a base consisting essentially of a tertiary amine having sufficient strength and concentration to drive the reaction between H₂S sorbed by said liquor and said dissolved sulfur to form a nonvolatile polysulfide which is soluble in the sorbing liquor, and a solubilizing agent for maintaining the solubility of polysulfide intermediates which may otherwise separate during the said process. The light hydrocarbons are absorbed in the liquor, from which they are subsequently separated. The dissolved nonvolatile polysulfide in the sorbing liquor is converted to sulfur which remains dissolved in the liquor by contacting the liquor with an oxidizing agent. At least part of the dissolved sulfur in the liquor is then converted to solid particulate sulfur at a point downstream of the absorber, and the solid sulfur is separated from the liquor.

### BRIEF DESCRIPTION OF DRAWINGS

In the drawings appended hereto:

FIG. 1 is a schematic block diagram of a conventional prior art hydrotreating system;

FIG. 2 is a further prior art showing, which schematically illustrates an aqueous alkanolamine system typically used for H₂S removal from hydrogen recycle streams along with the Claus sulfur recovery and tail gas treating (TGT) units that are required downstream;

FIG. 3 is a schematic block diagram illustrating in accordance with the invention, the conjunctive use with an HDS system of a nonaqueous process and system for removing H₂S while sponging light hydrocarbons and consuming less hydrogen; and

FIG. 4 shows the results of benchmarking studies for high-pressure gas applications comparing the process of the invention to the amine/Claus/tail gas treatment process.

### DESCRIPTION OF PREFERRED EMBODIMENT

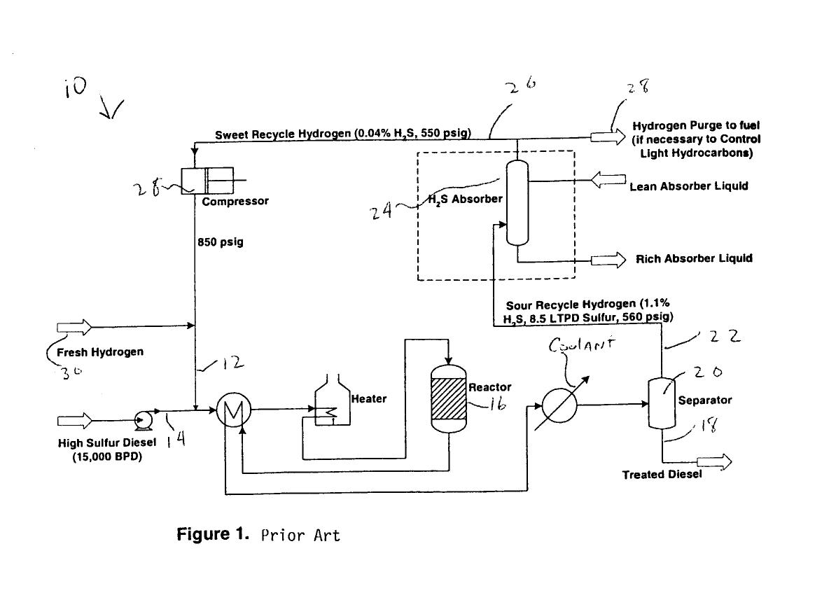

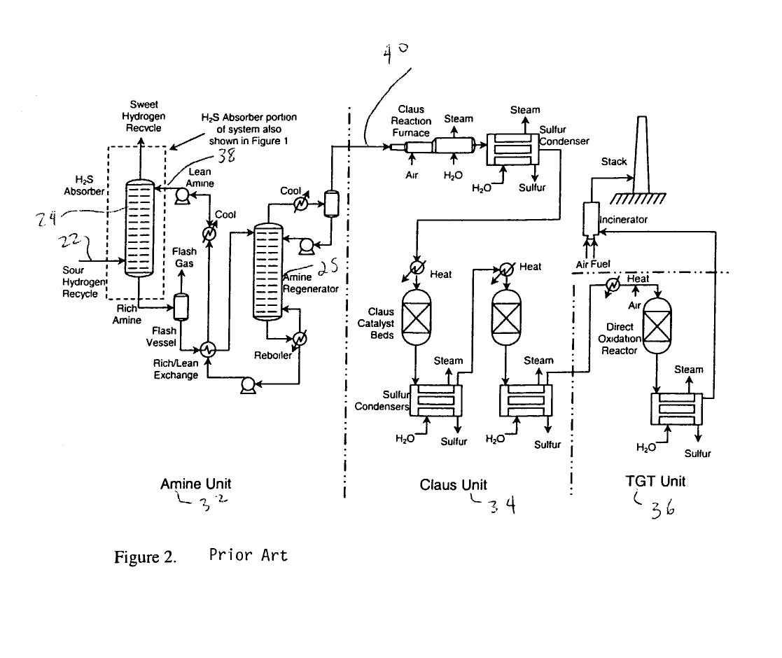

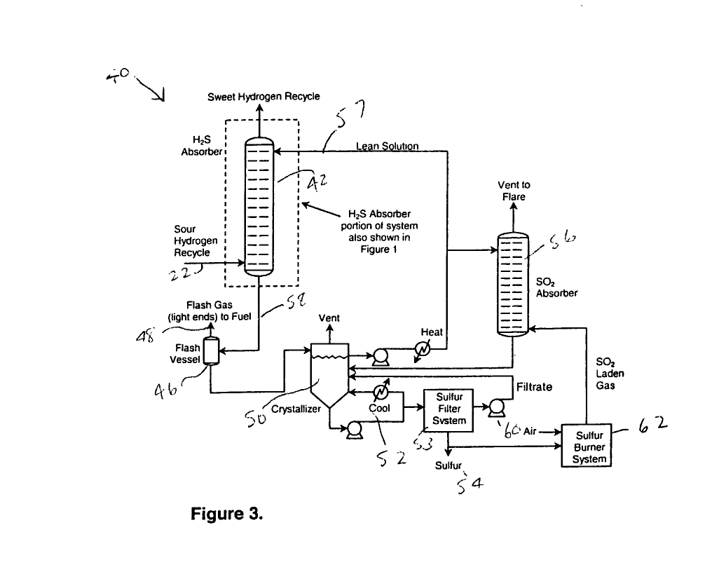

FIG. 3 shows an example of the nonaqueous scrubbing process and system of the invention. FIG. 3 can be considered in conjunction with FIG. 1 in that the absorber 42 in system 40 receives a hydrogen recycle stream 22 from an HDS system as in FIG. 1. Unlike the conventional operation in FIGS. 1 and 2, in system 40, a nonaqueous (hydrocarbon based) scrubbing solution 57 absorbs H₂S from the hydrogen recycle stream in a conventional trayed absorber 42 that operates at the same pressure as the hydrotreater. Once absorbed, H₂S reacts within the scrubbing solution to form elemental sulfur. The solution has a high solubility for elemental sulfur, so all of the sulfur formed stays in a dissolved state. There is no solid sulfur within the absorber section.

The present co inventor's cited U.S. Pat. No. 5,738,834, discloses as mentioned a process which uses a sulfur-amine nonaqueous sorbent (SANS) and operating conditions under which sulfur itself can convert hydrogen sulfide to polysulfides which are nonvolatile but which can be readily transformed to sulfur by reaction with an oxidizing agent. The nonaqueous liquid sorbing liquor (or scrubbing solution) disclosed therein may be used in the present invention and comprises an organic solvent for elemental sulfur, dissolved elemental sulfur, an organic base which drives the reaction converting H₂S sorbed by the liquor to a nonvolatile polysulfide which is soluble in the sorbing liquor, and an organic solubilizing agent which prevents the formation of polysulfide oil—which can tend to separate into a separate viscous liquid layer if allowed to form. The solubilizing agent is typically selected from the group consisting of aromatic alcohols and ethers including alkylarylpolyether alcohol, benzyl alcohol, phenethyl alcohol, 1-phenoxy-2-propanol, 2-phenoxyethanol, alkyl ethers including tri(propylene glycol) butyl ether, tri(propylene glycol) methyl ether, di(ethylene glycol) methyl ether, tri(ethylene glycol) dimethyl ether, benzhydrol, glycols such as tri(ethylene) glycol, and other polar organic compounds including sulfolane, propylene carbonate, and tributyl phosphate, and mixtures thereof. The sorbing liquor is preferably essentially water insoluble as this offers advantages where water may be condensed in the process. It is also preferable for water to be essentially insoluble in the solvent. The nonaqueous solvent is typically selected from the group consisting of alkyl-substituted naphthalenes, diaryl alkanes including phenylxylyl ethanes such as phenyl-o-xylylethane, phenyl tolyl ethanes, phenyl naphthyl ethanes, phenyl aryl alkanes, dibenzyl ether, diphenyl ether, partially hydrogenated terphenyls, partially hydrogenated diphenyl ethanes, partially hydrogenated naphthalenes, and mixtures thereof. In order to obtain a measurable conversion of sulfur and hydrogen sulfide to polysulfides, the base added to the solvent must be sufficiently strong and have sufficient concentration to drive the reaction of sulfur and hydrogen sulfide to form polysulfides. Most tertiary amines are suitable bases for this use. More particularly, tertiary amines including N,N dimethyloctylamine, N,N dimethyldecylamine, N,N dimethyldodecylamine, N,N dimethyltetradecylamine, N,N dimethylhexadecylamine, N-methyldicyclohexylamine, tri-n-butylamine, tetrabutylhexamethylenediamine, N-ethylpiperidine hexyl ether, 1-piperidineethanol, N-methyldiethanolamine, 2-(dibutylamino)ethanol, and mixtures thereof are suitable for use in the said process. It should be noted that while the solvent utilized in the process requires the addition of a base to promote the reaction of sulfur and hydrogen sulfide to form polysulfides, the base and the solvent may be the same compound.

Due to the fact that the nonaqueous scrubbing solution is itself composed primarily of hydrocarbon, the nonaqueous solution in the present invention tends to preferentially absorb (or dissolve) other light hydrocarbons (e.g., C₁-C₆) out of the hydrogen stream. The circulation rate can be adjusted so as to adjust the amount of light hydrocarbon scrubbed from the hydrogen stream.

The scrubbing solution 58 exiting from the absorber 42 is then flashed at flash vessel 46. The liberated gas 48 contains light hydrocarbons and other light materials that were physically absorbed. A key point is the composition of this flash gas, which contains about 50% light hydrocarbons. Due to the high concentration of light hydrocarbons that can be obtained in the flash gas 48, it is possible to adjust conditions such that all required light hydrocarbon removal occurs via the flash gas. As a result, much less hydrogen is lost than if one purged directly from the hydrogen recycle line as in the prior art of FIG. 1. Flash gas 48 can then be used as fuel in the present or other processes.

As taught in the referenced prior art patents the scrubbing solution from flash vessel 46, is then passed to a crystallizer 50, where a cooling loop 52 enables precipitation of solid sulfur in crystallizer 50. Sulfur 54 recovered by filter system 53 can be burned to SO₂, which can be used as the oxidizing gas for the H₂S, as disclosed in U.S. Pat. No. 6,416,729. Excess SO₂ is absorbed at an absorber 56 before being vented. The lean scrubbing solution 57 is recycled to absorber 42. The crystallizer/filter area is the only area where sulfur solids exist within the process. The crystallizer overflows to a surge tank (not shown). A heater in the surge tank ensures that all elemental sulfur is in a dissolved state. A conventional positive displacement pump 60 transfers the solution back to the absorber.

With the nonaqueous method and system utilized in the invention, H₂S is removed from the sour gas in a conventional tray absorber. The H₂S reacts with dissolved SO₂ and converts to dissolved elemental sulfur (no solid sulfur). Rich solution 58 from the absorber 42 passes to the flash step. In HDS applications, this is where the light hydrocarbons are removed from the system.

### EXAMPLE I

Some of the advantage flowing from use of a method and system based on the FIG. 3 arrangement were demonstrated by examining a diesel hydrotreater application at a 215,000 barrel per day (BPD) refinery. The refinery would need to install a hydrogen plant, a hydrotreater, and a sulfur recovery plant. Compared to traditional amine treating of the hydrogen recycle stream, the nonaqueous sulfur recovery approach used herein was calculated to save the refinery over $1 million per year in hydrogen costs alone (based on $2.50/MMBtu natural gas prices). Capital costs for the nonaqueous sulfur recovery approach were estimated at approximately 40% to 50% lower than amine/Claus/tail gas treating. Further, the nonaqueous sulfur recovery system has essentially infinite turndown for accommodating seasonal swings in diesel or gasoline demand.

Table 1 compares the composition for the hydrogen purge stream that would be necessary with a diethanolamine (DEA) treating system with composition of the flash gas from the nonaqueous sulfur recovery approach for the 215,000 BPD refinery case. As shown in the table, the flash gas from the nonaqueous sulfur recovery system removes more light hydrocarbons than using a DEA system for H₂S removal plus a hydrogen purge to control light hydrocarbons. Further, the flash gas removes much less hydrogen than the purge stream. The net savings of 32 lbmol/hr of hydrogen with the nonaqueous sulfur recovery approach represents approximately a 10% savings in total hydrogen use for this particular diesel HDS system. This refinery would realize an estimated savings of over $1 million per year at mid-2000 natural gas prices (i.e., $2.50 to $3.00 per MMBtu). The purge gas data given in Table 1 and the analysis of this refinery's situation are from a simulation of the nonaqueous sulfur recovery system.

TABLE 1
Comparison of processes

| | Hydrogen Purge | Flash Gas (applies | |
|---|---|---|---|
| | (applies if use | for nonaqueous | Advantage |
| Com- | conventional aqueous | sulfur recovery | of nonaqueous |
| ponent | amine, lbmol/hr) | approach, lbmol/hr) | approach |
| CO₂ | — | 0.003 | |
| H₂ | 46.3 | 14.3 | 32 lbmol/hr |
| | | | hydrogen saved |
| H₂S | 0.03 | — | |
| C₁ | 6.1 | 3.83 | |
| C₂ | 1.0 | 4.63 | |
| C₃ | 0.45 | 1.99 | |
| i-C₄ | 0.3 | 1.34 | |
| n-C₄ | 0.3 | 1.29 | |
| Total C₁ | | | |
| through | 8.15 | 13.08 | 4.93 lbmol/hr |
| C₄ | | | more light |
| Hydro- | | | ends removed |
| carbons | | | |
| Removed | | | |

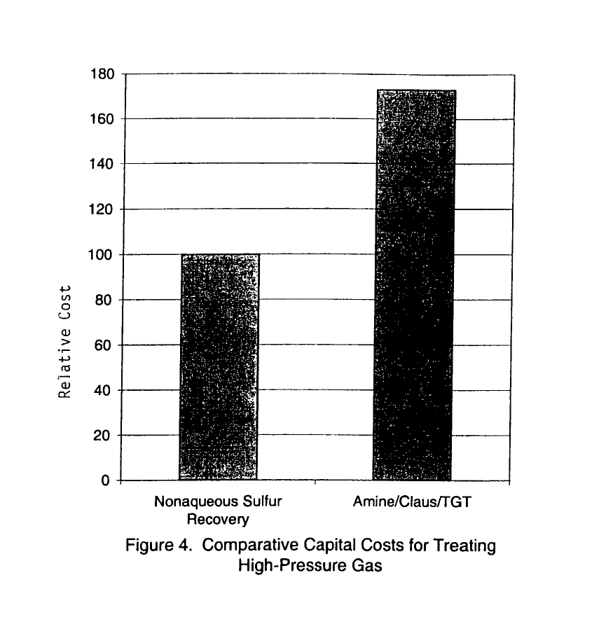

In addition to operating cost savings through reduced hydrogen loss, the nonaqueous sulfur recovery approach may also have 40% to 50% lower capital cost than conventional amine/Claus/TGT approaches. FIG. 4 shows the results of benchmarking studies for high-pressure gas applications. Capital reduction is possible, because the nonaqueous system both removes H₂S and converts it into elemental sulfur in a single unit. The conventional amine/Claus/TGT approach requires three separate process units. The differences in equipment become clear by comparing FIGS. 2 and 3.

In a further aspect of the invention, it has been found that the method and system of the invention can operate at much higher pressures than were previously deemed applicable in the aforementioned patents. This occurs because the process is being applied to a stream composed primarily of H₂. In natural gas and other cases, the maximum treatment pressure that can be considered is limited by increased evaporation of the scrubbing solution components into the primarily methane natural gas stream. For the methane streams, evaporation rates go up above approximately 300 psig and become exorbitantly high when one reaches 2000 psig and higher. In contrast, with hydrogen streams, the evaporation rate actually decreases with increasing pressure up to and above 3000 psig. This means that the present invention can be used on H₂ streams from even the highest pressure hydrotreaters (e.g., those for lube oil finishing), which operate in the range of 3000 psig and higher, and further that the unit can also be used on hydrogen recycle streams associated with hydrocrackers; hydrocrackers are hydroprocessing units with many similarities to HDS units, but that operate at highly elevated pressures and that have purposes, in addition to removing sulfur from the liquid hydrocarbon, that include cracking the liquid hydrocarbons into other molecules of higher value to the refiner.

A further advantage of the invention is that the nonaqueous solution has a high solubility for elemental sulfur. Because the elemental sulfur stays dissolved in the solution, there are no solids in the liquid that is circulated to the absorber, a key to reliable high-pressure operation.

For refinery applications, the SO₂ needed for the reactions can come from numerous sources. The nonaqueous solvent can be used to scrub SO₂ from another stream in the refinery (e.g., a combustion source that bums high sulfur fuel). If a refinery already has a separate amine system, a portion of the amine acid gas can be combusted and then scrubbed with the nonaqueous solvent. Pure SO₂ can always be purchased and metered into the lean solution line; this option is economical where SO₂ is readily available for purchase and sulfur throughputs are small. Alternately, a portion of the product sulfur can be burned as at 62, and the resulting SO₂ can be absorbed into the nonaqueous solution via a separate small SO₂ absorber 56 as depicted in FIG. 3.

The SO₂ that is added binds chemically with species within the nonaqueous solution. The bond is strong, and there is generally no detectable concentration of SO₂ in the gas phase anywhere within the system, including the sweetened gas. A large quantity of SO₂ can exist within the solution, and this background concentration creates a buffering effect, i.e., excess SO₂ bound within the solution ensures that there is plenty of SO₂ for the reaction stoichiometry. SO₂ flow can be completely cut off for short periods of time with little effect on H₂S removal. Brief fluctuations in SO₂ to H₂S ratios have no effect on the system, and it is not necessary to match SO₂ flow with H₂S flow on an instantaneous basis. Although HDS applications do not generally require the deep H₂S removal encountered in natural gas applications, the nonaqueous method and system described here does have the ability to remove H₂S to less than 4 ppmv. High CO₂ partial pressures have no effect on the process, and CO₂ is not removed by the process. Circulation rates are low, similar to those used for aqueous alkanolamine systems (see Table 2). Since there are no solids in the solution, efficient positive displacement pumps can be used. The solution has very low or no foaming tendencies because there are no surfactants or antifoams present in the system. Since the solution dissolves elemental sulfur, there are no solids present (except in the crystallizer/filter section).

TABLE 2
Comparison of Circulation Rates to H₂S Absorber
(0.2 vol % H₂S and 0.8 vol % CO₂)

| System | gpm/LTPD |
|---|---|
| Alkanolamine (MDEA) | 12-24 ^{a} |
| CrystaSulf nonaqueous sorbent | 20-50 |

^{a} Approximate range for solution strengths of 30-55 wt % and acid gas loadings of 0.45 to 0.50 mole/mole

The nonaqueous solution is also relatively noncorrosive.

The amount of hydrocarbon removed from the H₂ stream can be optimized. Liquid can be taken from the flash tank (after flashing off the light to mid-range hydrocarbons) and circulated back to a point in the absorber (e.g., the middle of the absorber). For example, if one wanted to remove twice as much hydrocarbons from the H₂ stream, enough liquid would be circulated to the middle part of the absorber so that the bottom portion of the absorber had twice as much scrubbing liquor flowing through it, giving approximately twice as much hydrocarbon pickup.

This recirculation of liquid from the flash tank to the absorber cannot be done with processes that concentrate H₂S (e.g., amine systems, physical H₂S solvent systems, etc.), because the processes that concentrate H₂S only scrub the H₂S. For example, if one circulates rich amine from the amine flash tank back to the absorber, the free H₂S in that rich amine strips back into the gas stream and compromises the ability of the H₂S absorber to remove H₂S to the desired specifications. In contrast, with the present invention the H₂S is converted to elemental sulfur by the time it gets to the flash tank. This means that one can circulate rich scrubber solution back to the absorber without affecting the absorber's ability to remove H₂S.

Reduced H₂ usage enabled by the invention also increases HDS catalyst life. There are in addition yet other benefits from the HDS system. For example, increased H₂ partial pressure going to the HDS reactor allows the reactor to be run at lower temperature (and still accomplish the desired desulfurization of the liquid hydrocarbon stream), which is the reason the catalyst can be run longer and give more on stream time. A system that has a higher H₂ partial pressure can employ different HDS catalysts in the HDS unit, catalysts that are less expensive or have higher reactivity. This gives refiners more opportunities for optimizing their refinery.

In addition to the light hydrocarbons thus far mentioned, the H₂ streams will have a full range of hydrocarbons at various concentrations in the vapor phase. It is important to assure that all hydrocarbons that enter the absorber 42 exit the system somewhere. In the cited prior art patents the absorber temperatures needed to support the chemical reactions in the absorber are discussed. Separate from the actual temperature of the absorber, it is also very important that there be a temperature rise across the H₂S absorber. That is, the absorber must run warmer than the inlet H₂ stream, at least 10° F. warmer or preferably much higher. This prevents the solution from absorbing too much of the heavier components. For example, in some cases, the inlet H₂ stream may be cooled prior to the absorber to remove traces of the heaviest components (e.g., C10+). Decreasing the inlet H₂ temperature prior to the absorber increases the temperature difference between the H₂ entering the absorber and the actual absorber temperature.

While the present invention has been set forth in terms of specific embodiments thereof, it will be understood in view of the present disclosure that numerous variations on the invention are now enabled to those skilled in the art. Accordingly, the present invention is to be broadly construed and limited only by the scope and spirit of the claims now appended hereto.

1. In a hydrodesulfurization process for removing sulfur from liquid hydrocarbons by reacting the sulfur in the liquid hydrocarbons with hydrogen to form H₂S, separating from the liquid hydrocarbons a sour hydrogen gas stream consisting of unreacted hydrogen, H₂S, and undesired light hydrocarbons; removing H₂S to sweeten the said hydrogen stream, separating at least some of the undesired light hydrocarbons; and thereupon recycling the hydrogen stream for further reaction in the process;
the improvement enabling efficient separation of the light hydrocarbons without substantial loss of recyclable hydrogen, comprising:
(a) separating both the H₂S and said light hydrocarbons from said sour hydrogen gas stream by passing the stream through an absorber where it is reacted with a liquor comprising a nonaqueous solvent containing dissolved sulfur, a base consisting essentially of a tertiary amine having sufficient strength and concentration to drive the reaction between H₂S sorbed by said liquor and said dissolved sulfur to form a nonvolatile polysulfide which is soluble in the sorbing liquor, and a solubilizing agent for maintaining the solubility of polysulfide intermediates which may otherwise separate during the said process; said light hydrocarbons being absorbed in said liquor;
(b) separating the light hydrocarbons from the sorbing liquor from step (a);
(c) converting the dissolved nonvolatile polysulfide in said sorbing liquor to sulfur which remains dissolved in said liquor by contacting the liquor with an oxidizing agent;
(d) converting at least part of said dissolved sulfur in the liquor to solid particulate sulfur at a point downstream of the absorber; and
(e) separating said solid sulfur from the liquor.

2. A process in accordance with claim 1, wherein the light hydrocarbons absorbed in said liquor are separated by passing the liquor from step (a) to a flash vessel and flashing the light hydrocarbons from the liquor

3. A process in accordance with claim 1 wherein SO₂ is used as the said oxidizing gas.

4. A process in accordance with claim 1 wherein the sour hydrogen gas stream is at a pressure of at least 2000 psig.

5. A process in accordance with claim 2, wherein a stream of sorbing liquor from the flash vessel is recirculated to the absorber to absorb further light hydrocarbons.

6. A process in accordance with claim 1, wherein the temperature in said absorber is at least 10 degrees F. higher than the gaseous sour hydrogen inlet stream to the absorber.

7. A process in accordance with claim 1 wherein said nonaqueous solvent is selected from the group consisting of alkyl-substituted naphthalenes, diaryl alkanes, phenyl-o-xylylethane, phenyl tolyl ethanes, phenyl naphthyl ethanes, phenyl aryl alkanes, dibenzyl ether, diphenyl ether, partially hydrogenated terphenyls, partially hydrogenated diphenyl ethanes, partially hydrogenated naphthalenes, and mixtures thereof.

8. A process in accordance with claim 7, wherein said base is selected from the group consisting of N,N dimethyloctylamine, N,N dimethyldecylamine, N,N dimethyldodecylamine, N,N dimethyltetradecylamine, N,N dimethylhexadecylamine, N-methyldicyclohexylamine, tri-n-butylamine, tetrabutylhexamethylenediamine, N-ethylpiperidine hexyl ether, 1-piperidineethanol, N-methyldiethanolamine, 2-(dibutylamino)ethanol, and mixtures thereof.

9. A process in accordance with claim 8 wherein said solubilizing agent is selected from one or more members of the group consisting of alkylarylpolyether alcohol, benzyl alcohol, phenethyl alcohol, 1-phenoxy-2-propanol, 2-phenoxyethanol, tri(propylene glycol) butyl ether, tri(propylene glycol) methyl ether, di(ethylene glycol) methyl ether, tri(ethylene glycol) dimethyl ether and benzhydrol.

10. A process in accordance with claim 8, wherein said solubilizing agent is selected from one or more polar organic compounds selected from the group consisting of sulfolane, propylene carbonate, and tributyl phosphate.

11. In a hydrodesulfurization system for removing sulfur from liquid hydrocarbons, and including reactor means for reacting the sulfur in the liquid hydrocarbons with hydrogen to form H₂S; separator means for separating from the reacted liquid hydrocarbons a sour hydrogen gas stream consisting of unreacted hydrogen, H₂S, and undesired light hydrocarbons; absorber means for contacting the sour hydrogen stream with a scrubbing composition, for removing H₂S from the said sour hydrogen stream to sweeten the said hydrogen stream; means for separating at least some of the undesired light hydrocarbons from said sweetened hydrogen stream; and means for recycling the hydrogen stream to said reactor for further reaction;
the improvement enabling efficient separation of the light hydrocarbons without substantial loss of recyclable hydrogen, comprising:
said absorber means for removing H₂S to sweeten the said hydrogen stream being the same said means which separated at last some of the undesired light hydrocarbons.

12. A system in accordance with claim 11, wherein said absorber means which separates both the H₂S and said light hydrocarbons from said sour hydrogen gas stream, contacts the stream with a liquor comprising a nonaqueous solvent containing dissolved sulfur, a base consisting essentially of a tertiary amine having sufficient strength and concentration to drive the reaction between H₂S sorbed by said liquor and said dissolved sulfur to form a nonvolatile polysulfide which is soluble in the sorbing liquor, and a solubilizing agent for maintaining the solubility of polysulfide intermediates which may otherwise separate during the said process; said light hydrocarbons being absorbed in said liquor; and
means for separating the light hydrocarbons from the sorbing liquor exiting said absorber;
means for converting the dissolved nonvolatile polysulfide in said sorbing liquor to sulfur which remains dissolved in said liquor by contacting the liquor with an oxidizing agent;
means for converting at least part of said dissolved sulfur in the liquor to solid particulate sulfur at a point downstream of the absorber; and
means for separating said solid sulfur from the liquor.

13. A system in accordance with claim 12, wherein said means for separating said light hydrogens, includes a flash vessel for receiving the spent scrubbing liquor from said absorber means, and flashing the light hydrocarbons from the liquor

14. A system in accordance with claim 12, further including means for introducing SO₂ into said system as the said oxidizing gas.

15. A system in accordance with claim 14, further including means for recirculating a stream of sorbing liquor from said flash vessel to said absorber to absorb further light hydrocarbons and H₂S.
